(19) United States
(12) Patent Application Publication
(10) Pub. No.: US 2013/0159462 A1
(43) Pub. Date: Jun. 20, 2013

(54) ELECTRONIC APPARATUS AND INFORMATION DISTRIBUTION METHOD

(71) Applicants: Kohji SAIKI, Kawasaki-shi (JP); Toshifumi OHTAKE, Chofu-shi (JP)

(72) Inventors: Kohji SAIKI, Kawasaki-shi (JP); Toshifumi OHTAKE, Chofu-shi (JP)

(73) Assignee: KABUSHIKI KAISHA TOSHIBA, Tokyo (JP)

(21) Appl. No.: 13/712,074

(22) Filed: Dec. 12, 2012

(30) Foreign Application Priority Data
Dec. 16, 2011 (JP) 2011-275535

(51) Int. Cl. H04L 29/08

(52) U.S. Cl. CPC H04L 67/32
USPC 709/217

(57) ABSTRACT

According to one embodiment, an electronic apparatus includes an input module, a transmitter, a receiver and a display. The input module is configured to input, from a first device, process result data indicative of a result of a process executed by the first device, and connection data for access to a second device. The transmitter is configured to access the second device, based on the connection data, and to transmit the process result data. The receiver is configured to receive totalization data of the process result data from the second device. The display is configured to display a totalization screen, based on the totalization data.

### CROSS-REFERENCE TO RELATED APPLICATIONS

This application is based upon and claims the benefit of priority from prior Japanese Patent Application No. 2011-275535, filed Dec. 16, 2011, the entire contents of which are incorporated herein by reference.

### FIELD

Embodiments described herein relate generally to an electronic apparatus which distributes information via a network, and an information distribution method.

### BACKGROUND

In general, in order to promote sales of commodities, it is necessary to inform consumers of features, etc. of the commodities. For example, in the case of selling personal computers, the personal computers are exhibited in outlet stores so that consumers may operate them, or descriptions of functions of personal computers are presented on homepages so that consumers may be informed via the Internet. In addition, there are advertisements by TV commercials or printed matters such as magazines.

Conventionally, as described above, a plurality of different information distribution methods are implemented in combination, so that commodities may be known to a larger number of consumers.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating a system according to an embodiment.

FIG. 2 is an exemplary view which schematically illustrates information distribution in the embodiment.

FIG. 3 is an exemplary block diagram illustrating the structure of a mobile terminal in the embodiment.

FIG. 4 is an exemplary block diagram illustrating the structure of a service server in the embodiment.

FIG. 5 is an exemplary view illustrating ranking management data in the embodiment.

FIG. 6 is an exemplary block diagram illustrating the structure of a personal computer in the embodiment.

FIG. 7 is an exemplary flow chart illustrating the operation of the personal computer in the embodiment.

FIG. 8 is an exemplary flow chart illustrating the operation of the personal computer in the embodiment.

FIG. 9 is an exemplary flow chart illustrating the operation of the mobile terminal in the embodiment.

FIG. 10 is an exemplary flow chart illustrating the operation of the service server (special site) in the embodiment.

FIG. 11 shows an example of a game result screen in the embodiment.

FIG. 12 shows an example of a game ranking screen which is displayed on the personal computer of the embodiment.

FIG. 13 shows an example of a game ranking screen which is displayed on the mobile terminal of the embodiment.

FIG. 14 shows an example of a posting page screen which is displayed on the mobile terminal of the embodiment.

FIG. 15 shows an example of the posting page screen which is displayed on the mobile terminal of the embodiment.

FIG. 16 shows an example of the posting page screen which is displayed on the mobile terminal of the embodiment.

### DETAILED DESCRIPTION

Various embodiments will be described hereinafter with reference to the accompanying drawings.

In general, according to one embodiment, an electronic apparatus comprises an input module, a transmitter, a receiver and a display. The input module is configured to input, from a first device, process result data indicative of a result of a process executed by the first device, and connection data for access to a second device. The transmitter is configured to access the second device, based on the connection data, and to transmit the process result data. The receiver is configured to receive totalization data of the process result data from the second device. The display is configured to display a totalization screen, based on the totalization data.

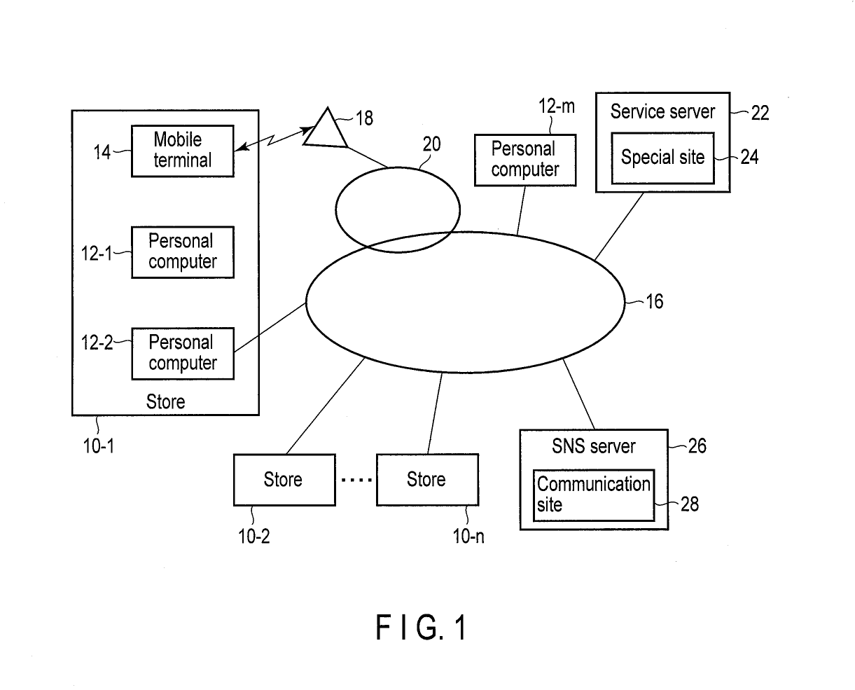

FIG. 1 is a block diagram illustrating a system according to an embodiment. In the embodiment, a description is given of an information distribution method which distributes information relating to commodities to consumers, thereby to promote sales of the commodities. In the description below, personal computers are described as examples of commodities that are targets of sales promotion.

In stores 10 (10-1, 10-2, . . . , 10-n) shown in FIG. 1, personal computers that are targets of sales promotion are exhibited. For example, personal computers 12 (12-1, 12-2) are disposed in the store 10-1. A consumer may visit the store 10-1, thus being able to operate the personal computers 12. Thereby, the consumer can try characteristic features which are implemented in the personal computers 12. In the example illustrated, the personal computer 12-1, which is exhibited in the store 10-1, is not connected to a network, while the personal computer 12-2, which is exhibited, is connectable to the network.

In the personal computer 12-1, 12-2 in the embodiment, a game program for executing a game, which makes use of a characteristic function, is installed so that the consumer may try the characteristic function.

Similarly, it is assumed that a plurality of personal computers are exhibited in other stores 10-2, . . . , 10-n. In addition, it is assumed that a personal computer 12-m, for instance, was purchased by a consumer, and is being used, for example, in the home in the state in which the personal computer 12-m is connectable to the Internet 16. Like the personal computers 12-1 and 12-2, in the personal computer 12-m, the game program of the game, which makes use of the characteristic function, is installed.

A mobile terminal 14 is an electronic apparatus which is possessed by, for example, a consumer who has visited the store 10-1. The mobile terminal 14 is, for instance, a smartphone, a mobile phone, or a slate PC, and has a communication function of connecting to a public telephone network 20 by wireless communication with a base station 18. The mobile terminal 14 can connect to the Internet 16 via the public telephone network 20, and can access a special site 24 which is opened by a service server 22 or a communication site 28 which is opened by an SNS (Social Networking Service) server 26.

The service server 22 opens, via the Internet 16, the special site 24 for providing a service for effectively distributing information of commodities (personal computers 12). The special site 24 can be accessed from, for example, the personal computer 12-2 or 12-m or from the mobile terminal 14. The personal computer 12-2, 12-m executes, for example, the game program, thereby displaying on a game result screen a link button which sets the special site 24 as a link destination. With the link button being selected by the user, the personal computer 12-2, 12-m accesses the special site 24.

The special site 24 includes a function of managing results of games (e.g. score ranking) which were executed in the personal computers 12-1, . . . , 12-m, and a function of mediating between the personal computer 12-2, 12-m, or mobile terminal 14, and the communication site 28.

The address (e.g. URL (uniform resource locator) of the special site 24 is input from the personal computer 12-1, 12-2, and the mobile terminal 14 accesses the special site 24, based on the URL. For example, the personal computer 12-1, 12-2 executes the game program, thereby displaying on the game result screen a two-dimensional code (e.g. QR (Quick response) code) including the address (URL) of the special site 24. The mobile terminal 14 reads the URL of the special site 24 from the two-dimensional code, and accesses the special site 24, based on this URL.

The SNS server 26 opens, via the Internet 16, the communication site 28 for providing a service in which participating users make their information public, thereby enabling communication between the users. For example, the communication site 28 provides a service by which users can mutually view messages written by themselves. It is assumed that accounts have been issued to users in advance, in order to use the service that is provided by the communication site 28.

It is assumed that the account for using the service, which is provided by the communication site 28, is recorded in advance in the mobile terminal 14.

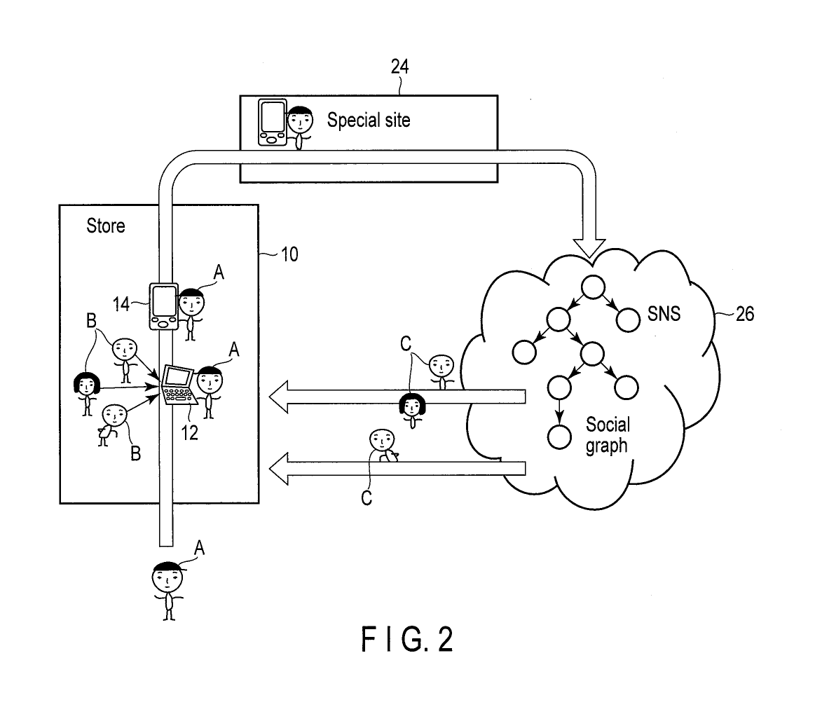

To begin with, the outline of information distribution in the embodiment is described with reference to FIG. 2.

A consumer A may visit a store, thus being able to operate the personal computer 12 which is exhibited in the store. In the personal computer 12, a game program for executing a game, which makes use of characteristic functions, is installed so that the consumer A may try the characteristic functions.

The characteristic functions include, for example, a gesture recognition function and a speech recognition function. The gesture recognition function is a function of photographing the gesture of the user by a camera and discriminating an input instruction (command) based on a difference in gesture. The speech recognition function is a function of inputting the user's speech, discriminating the content of the speech, and responding to the content of the speech by a screen and a speech. Meanwhile, the personal computer 12 may be provided with characteristic functions which are different from the gesture recognition function and the speech recognition function.

The consumer A can learn with enjoyment the features of the personal computer 12 by executing the game of the personal computer 12. Thus, the consumer A can easily deepen understanding of the personal computer 12. In addition, the work load of a store clerk, who explains commodities to the consumer A, can be reduced.

On the other hand, if the consumer A executes the game by the personal computer 12, it is possible to make another consumer B, who is viewing the consumer A executing the game, have interest in the personal computer 12. Therefore, it can be expected that the consumer B, too, executes the game by the personal computer 12. Specifically, with a consumer executing the game with the personal computer 12, it is possible to increase the number of consumers who pay attention to the personal computer 12.

In addition, by executing the game in the personal computer 12, the consumer A can access the special site 24 from, for example, a game result screen, and can upload the score of the game obtained by the consumer A. For example, in such an environment that the personal computer 12 is connectable to the Internet 16, the consumer A may select a link button which is set on the game result screen, thus being able to connect the personal computer 12 to the special site 24. In addition, when the personal computer 12 is not in such an environment as to be connectable to the Internet 16, the consumer A may read a two-dimensional code displayed on the game result screen, by using his/her own mobile terminal 14, and thereby the consumer A can access the special site 24 by using the URL of the special site 24 included in the two-dimensional code. Data indicative of the score obtained in the game is added to the URL that is included in the two-dimensional code. Thus, the score of the game can be uploaded to the special site 24 by accessing the special site 24 by using the URL that has been read from the two-dimensional code.

In the special site 24, the scores, which have been uploaded from the personal computers 12 and mobile terminal 14, are classified, for example, by stores, by regions, etc., so that these scores can be viewed in a ranking format. Thereby, the consumer A, who executed the game in the personal computer 12, can be prompted to access the special site 24. Specifically, since the scores can be viewed in the ranking format, the comparison with scores of other consumers becomes easy, and the consumer A can be more motivated to execute the game, targeting a higher scope.

In addition, the consumer A accesses the special site 24 for uploading the score of the game. Thereby, the special site 24 can provide the consumer A with a special page on which advertisements of commodities, for instance, are posted. Thus, the effect of advertisement can be expected for the consumer A who executed the game in the personal computer 12.

For the store 10, the ability to attract customers can be improved by exhibiting personal computers 12 with which games can be played. In addition, for the sales maker of the personal computers 12, by enabling the personal computers 12 to execute games, the ratio of contact with the personal computers 12 by consumers is improved and the increase in sales can be expected.

The special site 24 includes, in addition to the above-described ranking management function, a function of mediating between the personal computer 12 or mobile terminal 14, and the communication site 28. For example, the mobile terminal 14 accesses the special site 24 to display a game ranking screen. Thereby, through this game ranking screen, the mobile terminal 14 can access a posting page of the SNS server 26 (communication site 28). The consumer A can access the communication site 28 via the special site 24 and can post, for example, information relating to the game of the personal computer 12. In the meantime, when the special site 24 mediates between the mobile terminal 14 and the communication site 28, the special site 24 inserts in advance, in a posting description field of the posting page, for example, information of scores, ranks, etc. of games, and addresses (URL) of an advertisement page which introduces details, etc. of personal computers 12, and a coupon page which displays coupons for discount which can be received when commodities are purchased. Thereby, the posting of information relating to the game by the consumer A is made easier.

In addition, an identification code for identifying the consumer A is input through the game ranking screen, and is transmitted to the special site 24. Thereby, in the special site 24, the identification code can be added to the URL which is inserted in the posting description field of the posting page. Thus, the consumer A can easily post the URL to which the identification data that can identify the consumer A is added.

In the meantime, when the account of the communication site 28 has already been set in the mobile terminal 14, the special site 24 makes the consumer A access the special site 24 by using this account. Thereby, the content of posting relating to the game by the consumer A can effectively be communicated to a social graph which is constructed by the consumer A in the communication site 28, that is, to other related users who participate in the communication site 28. In the communication site 28, if the social graph of the consumer A is constructed, the content of posting can quickly be diffused to a wide range of users at low cost, via the connections between users in the SNS. For example, if there are other users who follow the consumer A, the posting by the consumer A is communicated to the other users who follow the consumer A. In addition, the other users may quote the content of posting by the consumer A and may re-post the content, and thereby the content of posting by the consumer A can be communicated more widely. Hence, the degree of recognition of the personal computer 12 can be enhanced. Moreover, it can be expected that other users who are interested in the personal computer 12 by the content of posting in the communication site 28 visit the store 10 as new consumers C.

When the URL of an advertisement page or a coupon page is included in the posted content, if access is made based on the URL, the identification data can be extracted at the accessed site. More posting can be prompted by returning profits to the poster (consumer A), based on the identification data.

As described above, the consumer A is enabled to execute the game in the personal computer 12 which is exhibited in the store 10. Thereby, the consumer A is prompted to access the special site 24 and then prompted to post messages to the communication site 28 via the special site 24. In the communication site 28, the content posted by the consumer A is communicated, based on the social graph. Therefore, the information relating to the personal computer 12 can effectively be distributed.

Next, the structures of the mobile terminal 14, service server 22 and personal computer 12 are described.

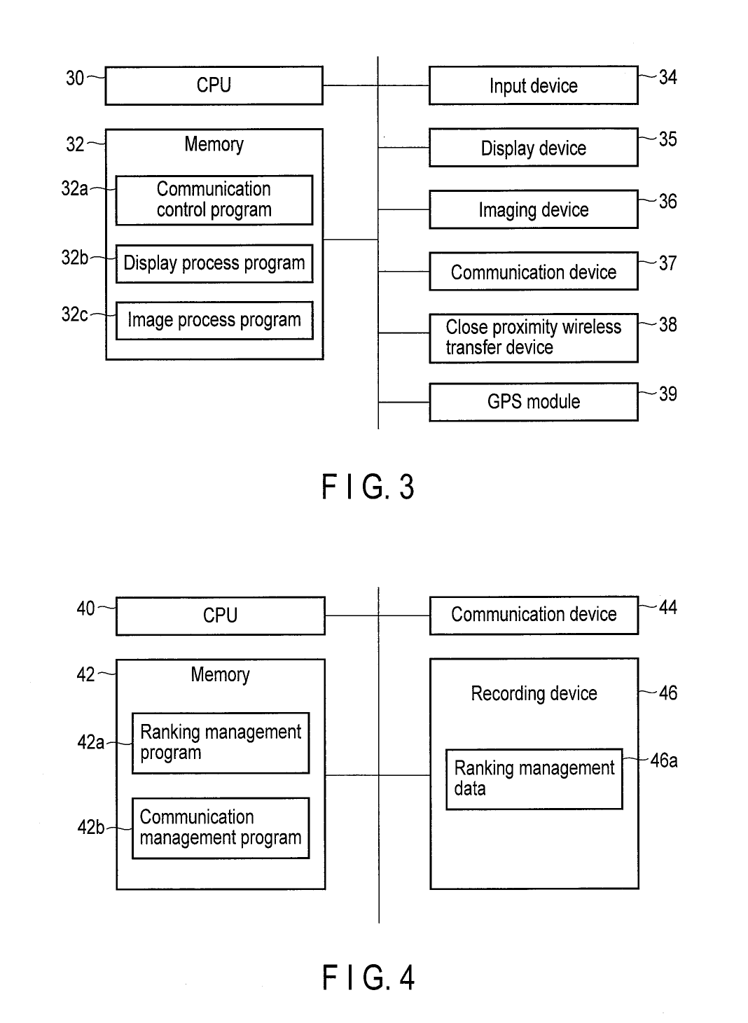

FIG. 3 is an exemplary block diagram illustrating the structure of the mobile terminal 14 in the embodiment. As shown in FIG. 3, the mobile terminal 14 includes a CPU 30, a memory 32, an input device 34, a display device 35, an camera 36, a communication device 37, a close proximity wireless transfer device 38, and a GPS (Global Positioning System) module 39.

The CPU 30 executes various programs which are recorded in the memory 32, thereby controlling the respective components and realizing various functions.

Various programs and data are recorded in the memory 32. The programs recorded in the memory 32 include, as well as a basic program, various application programs, a communication control program 32a, a display process program 32b, and an image process program 32c. In addition, data indicative of an account for making use of a service, which is provided by the SNS server 26 (communication site 28), is recorded in the memory 32.

The communication control program 32a executes communication control via the public telephone network 20 by the communication device 37, and close proximity wireless transfer control by the close proximity wireless transfer device 38. The display process program 32b controls display on the display device 35. The image process program 32c executes a process on an image which is captured by the camera 36. When an image including a two-dimensional code has been captured by the camera 36, the image process program 32c decodes the two-dimensional code and acquires data indicated by the two-dimensional code. In the embodiment, the two-dimensional code includes an address (URL) of the special site 24, a gate result (score), a character name of a character used in the game, a date, and identification data which is unique to the two-dimensional code. Incidentally, the identification data, which is unique to the two-dimensional code, is used in order to discriminate erroneous transmission or overlapping transmission to the special site 24.

The input device 34 is a device which accepts an input operation by a user, and is, for instance, a touch panel, a keyboard, a button, etc.

The display device 35 is composed of, e.g. an LCD (Liquid Crystal Display). In the case where the mobile terminal 14 is a smartphone, a touch screen is constructed by laying a touch panel, which is provided as the input device 34, over a display surface of the display device 35.

The camera 36 captures a still image or a moving picture, under the control of the CPU 30.

The communication device 37, under the control of the CPU 30, connects to the public telephone network 20 (Internet 16) via the base station 18. In the meantime, the communication device 37 can acquire position data indicative of the place of installment of the base station 18, by the communication with the base station 18.

The close proximity wireless transfer device 38, under the control of the CPU 30, executes close proximity wireless transfer with a close proximity wireless transfer device which is provided, for example, in some other electronic apparatus.

The GPS module 39 calculates position data, based on a signal which is received from a GPS satellite.

FIG. 4 is an exemplary block diagram illustrating the structure of the service server 22 in the embodiment. As shown in FIG. 4, the service server 22 includes a CPU 40, a memory 42, a communication device 44 and a recording device 46.

The CPU 40 executes various programs which are recorded in the memory 42, thereby controlling the respective components and realizing various functions.

Various programs and data are recorded in the memory 42. The programs recorded in the memory 42 include, as well as a basic program, various application programs, a ranking management program 42a, and a communication management program 42b.

The ranking management program 42a realizes a function of managing a result of a game (e.g. score ranking) which has been executed in personal computers. The ranking management program 42a totalizes game scores, which are transmitted from the personal computers 12 exhibited in the stores 10-1, 10-2, . . . , 10-n, or from the mobile terminal 14 which has read game results, for example, in a ranking format by regions or by stores, and provides a game ranking screen.

The communication management program 42b realizes a function of mediating between the personal computer in which the game was executed or the mobile terminal, on the one hand, and the communication site 28, on the other hand. When a request for posting to the communication site 28 has been input through the game ranking screen, the communication management program 42b provides the personal computer or mobile terminal, which is the source of the request for posting, with a posting page for posting to the communication site 28. At this time, the communication management program 42b inserts in advance, in the posting description field of the posting page, for example, information of scores, ranks, etc. of games, and addresses (URL) of an advertisement page which introduces details, etc. of personal computers 12, and a coupon page which displays coupons for discount which can be received when commodities are purchased.

The communication device 44 controls communication with some other electronic device via the Internet 16.

The recoding device 46 records various data. For example, the recording device 46 records ranking management data 46a which is processed by the ranking management program 42a.

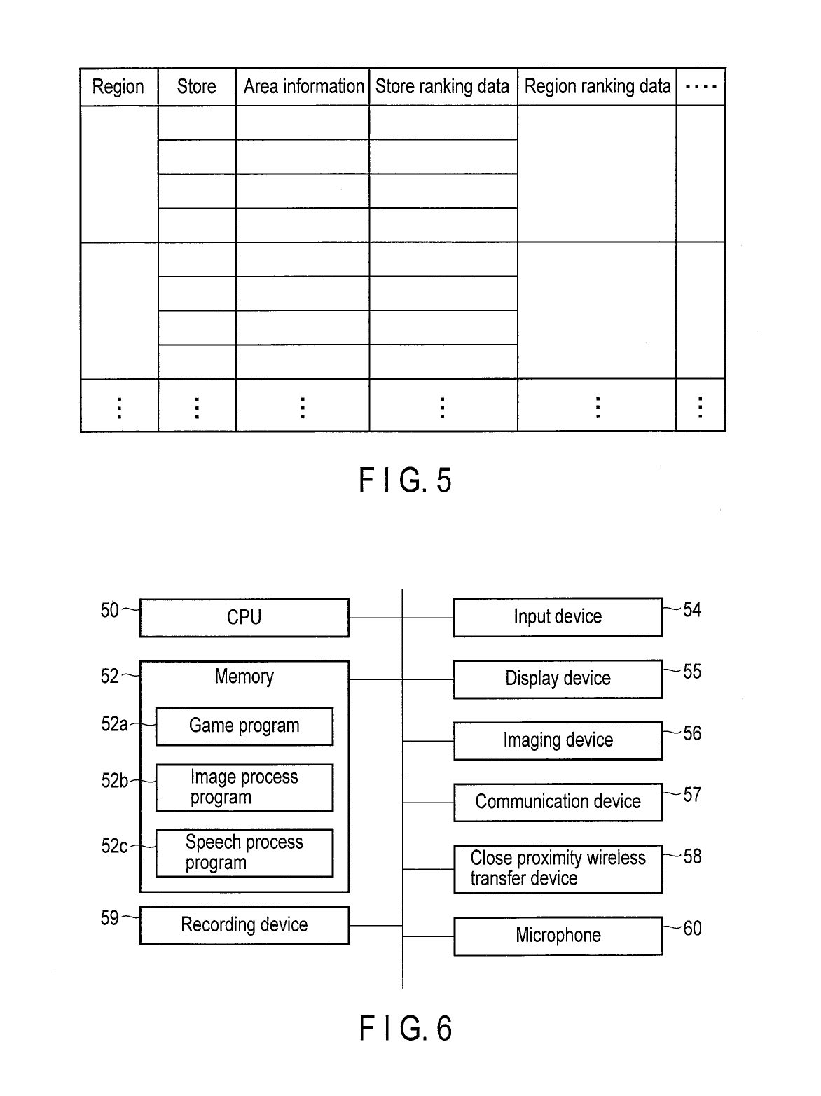

FIG. 5 shows the ranking management data 46a in the embodiment. As shown in FIG. 5, in the ranking management data 46a, stores included in predetermined regions are set in association with the respective regions. In connection with each store, area information for discriminating the location of the store, based on position data which is input from the personal computer 12 or mobile terminal 14, is set. The area information may be information of an area which is demarcated by, e.g. the latitude and longitude, or information of an area which is demarcated by addresses. In addition, store ranking data, which is associated with each store, and region ranking data, which is associated with each region, are set. The store/region ranking data includes scores which were obtained by games executed in the personal computers 12, and character names of characters used in the games.

FIG. 6 is an exemplary block diagram illustrating the structure of the personal computer 12 in the embodiment. As shown in FIG. 6, the personal computer 12 includes a CPU 50, a memory 52, an input device 54, a display device 55, an camera 56, a communication device 57, a close proximity wireless transfer device 58, a recording device 59, and a microphone 60.

The CPU 50 executes various programs which are recorded in the memory 52, thereby controlling the respective components and realizing various functions.

Various programs and data are recorded in the memory 52. The programs recorded in the memory 52 include, as well as a basic program, various application programs, a game program 52a, an image process program 52b and a speech process program 52c.

The game program 52a executes a game which makes use of characteristic functions (e.g. gesture recognition function and speech recognition function) which are implemented in the personal computer 12. The game program 52a displays, on the game result screen, link button which sets the special site 24 as a link destination, and a two-dimensional code including the address (URL) of the special site 24.

The image process program 52b executes a process for the gesture cognition function. The image process program 52b detects an object (e.g. hand), which is a target of recognition, from an image captured by the camera 60, and discriminates an input instruction (command), based on the movement of the object.

The speech recognition program 52c executes a process for the speech recognition function. The speech recognition program 52c recognizes speech which is input by the microphone 61, and discriminates the content of the speech.

The input device 54 is a device which accepts an input operation by a user, and is composed of a touch panel, a keyboard, a mouse, etc.

The display device 55 is composed of, e.g. an LCD.

The camera 56 captures an image. For example, an imaging range, within which an image including the face or hand of a person who is operating the personal computer 12 can be captured, is set in the camera 56.

The communication device 57 controls communication with some other electronic device via the Internet 16.

The close proximity wireless transfer device 58, under the control of the CPU 50, executes close proximity wireless transfer with a close proximity wireless transfer device which is provided, for example, in some other electronic apparatus.

The recording device 59 records various programs and data.

The microphone 60 inputs speech.

Next, the operation of the system in the embodiment is described.

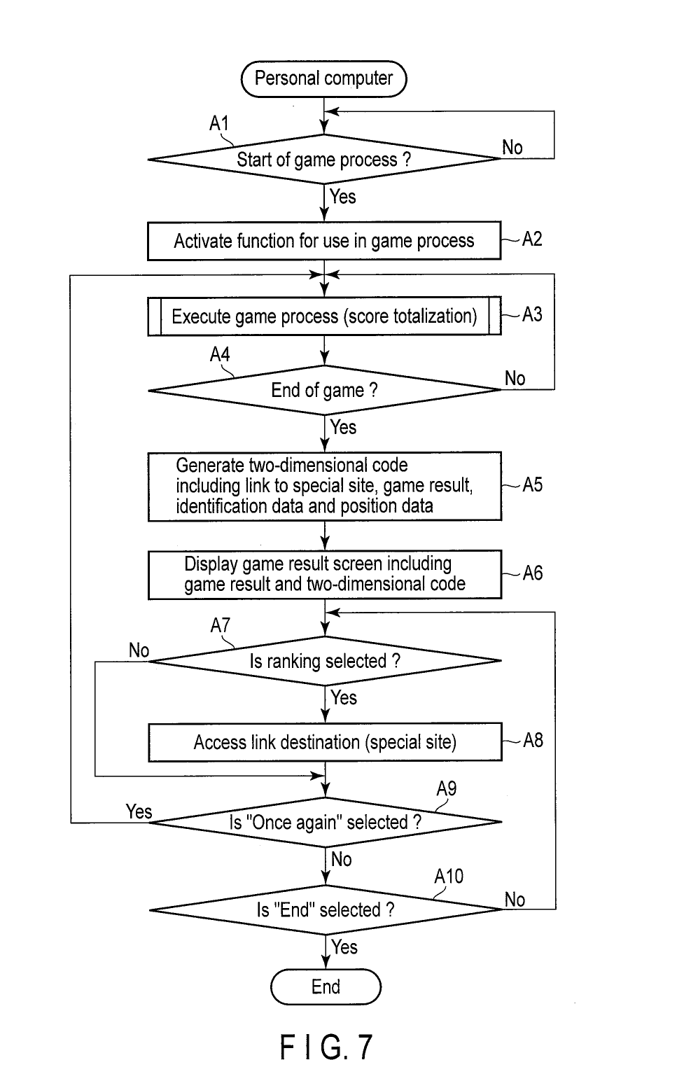

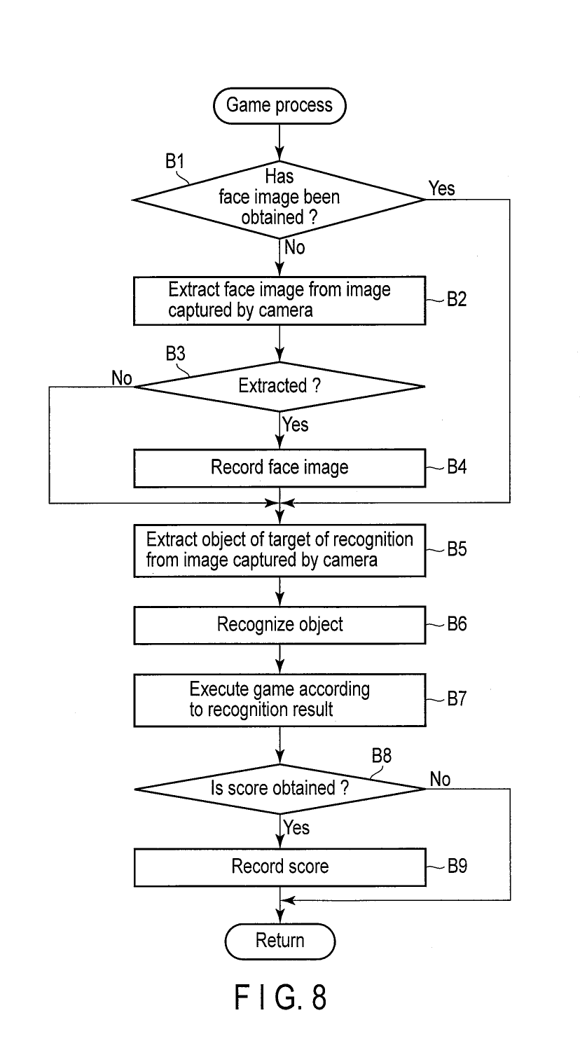

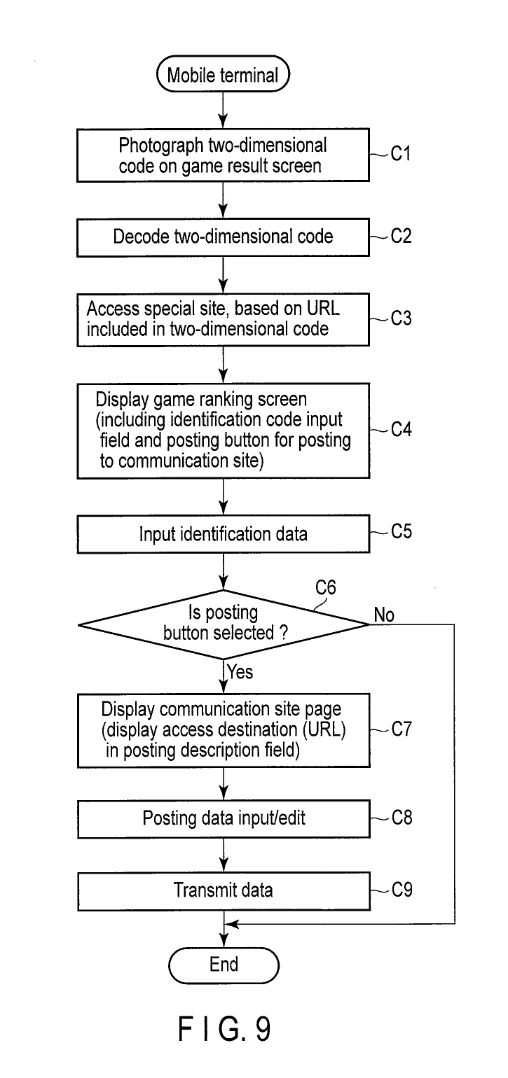

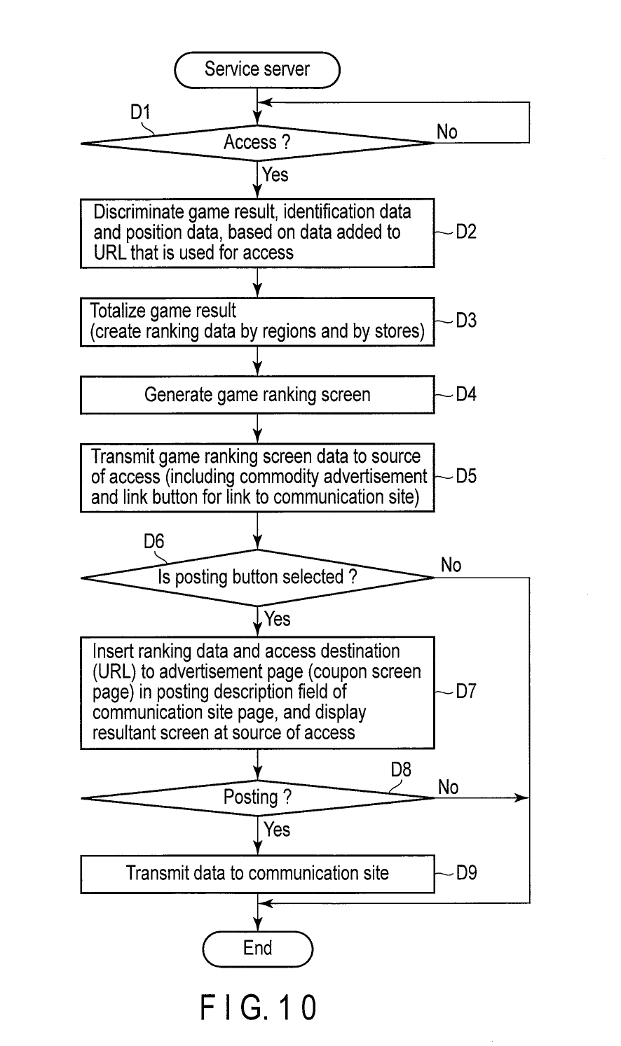

FIG. 7 and FIG. 8 are exemplary flow charts illustrating the operation of the personal computer 12 in the embodiment. FIG. 9 is an exemplary flow chart illustrating the operation of the mobile terminal 14 in the embodiment. FIG. 10 is an exemplary flow chart illustrating the operation of the service server 22 (special site 24) in the embodiment.

To start with, if the execution of a game is instructed by a consumer who has visited the store 10, the personal computer 12 that is exhibited in the store 10 activates the game program 52a and starts a game process (block A1). The CPU 50 of the personal computer 12 activates functions which are used in the game process that is executed by the game program 52a (block A2). For example, when the gesture recognition function is used in the game process, the CPU 50 activates the image process program 52b, thereby enabling a process on an image which is captured by the camera 56.

Then, the CPU 50 executes the game process (block A3). In the game process, for example, a character, which responds to an input operation by the consumer A, is displayed. For example, the consumer A can set an arbitrary name (character name) for the character.

FIG. 8 is a flow chart of the game which uses the gesture recognition function.

If the game process is started, the CPU 50 extracts a face image from the image captured by the camera 56, by the process of the image process program 52b. Specifically, the CPU 50 extracts the image which is to be uploaded to the special site 24 after the end of the game.

In the game process of the embodiment, the CPU 50 executes a face image extraction process on the image captured by the camera 56 (block B2). When the face image has successfully been extracted (Yes in block B3), the CPU 50 records the face image data in the recording device 59. If the recording of face image data has been completed (Yes in block B1), the CPU 50 skips the face image extraction process in a subsequent game process.

In the meantime, the recording of the face image may be executed at a timing when the face image has been extracted during the game process, as described above, or may be executed at a predetermined timing. When the recording of the face image is executed at the predetermined timing, for example, the recording may be executed upon informing the consumer A of the recording of the face image, at a time before the start of the game or after the end of the game, or the recording may be executed at a specific scene in the game process (e.g. at a time when an event has occurred, at a time when a score has been obtained, etc.).

In the game process using the gesture recognition function, the CPU 50 extracts, based on the shape or color, an object that is a target of recognition, from the image captured by the camera 56. In this case, an image corresponding to the hand (hand image) is extracted as the object that is the target of recognition.

If the object is extracted, the CPU 50 executes recognition as to whether a predetermined gesture is performed or not, for example, based on the variation of the shape of the object (hand image) (block B6). When the predetermined gesture has been recognized, the CPU 50 discriminates an input instruction (command), based on a difference in gesture, and controls the game in accordance with the input instruction (block B7). If a score is obtained by the control of the game corresponding to the input operation, the CPU 50 records the obtained score by adding it to the total score obtained thus far (block B9). Until the end of the game, the CPU 50 continues the game process using the gesture recognition function (No in block A4).

If the game ends, the CPU 50 generates a two-dimensional code including the address (URL) of the special site 24, the game result (score), the character name of the character used in the game, the date, and the identification data that is unique to the two-dimensional code (block A5). The CPU 50 causes the display device 55 to display a game result screen including the two-dimensional code and the game result.

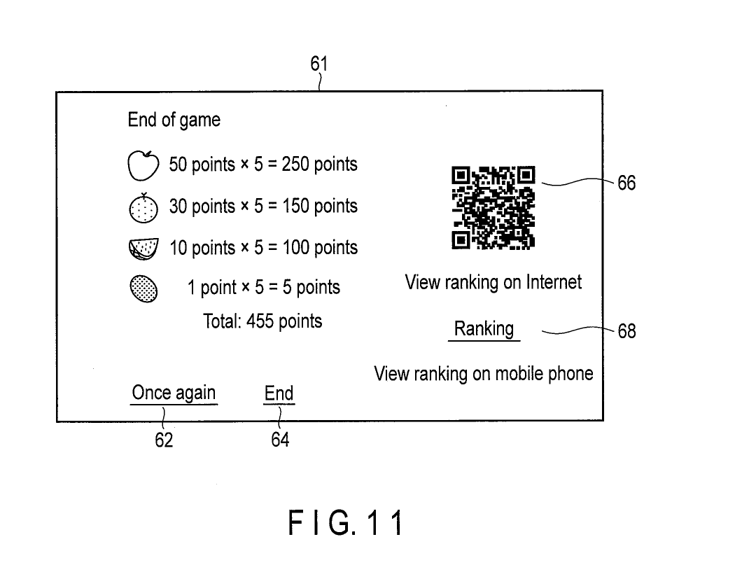

FIG. 11 shows an example of a game result screen 61 in the embodiment. The game result screen 61 shown in FIG. 11 includes a “Once again” button 62 for instructing the execution of the game once again, and an “End” button 64 for instructing the end of the game, in addition to the details of the score obtained in the game process. In addition, the game result screen 61 includes a two-dimensional code 66 including the URL of the special site 24, and a “Ranking” button 68 for instructing display of a game ranking screen. In the “Ranking” button 68, a game ranking screen, which is provided by the special site 24, is set as a link destination.

If the “Once again” button 62 is selected (Yes in block A9), the CPU 50 executes the game process once again (block A3). If the “End” button 64 is selected (Yes in block A10), the CPU 50 terminates the game process.

When the “Ranking” button 68 is selected, the CPU 50 accesses the link destination that is set in the “Ranking” button 68, namely the special site 24, via the communication device 57 (block A8). At this time, the CPU 50 transmits (uploads) to the special site 24 the game result (score), the character name of the character used in the game, the date, the identification data and the position data. The position data may be preset by the game program 52a. It is assumed, for example, that the position data is indicative of the address and the latitude/longitude of the store 10 in which the personal computer 12 is exhibited.

By transmitting the game result (score) to the special site 24 from the personal computer 12, the game ranking screen is generated in the special site 24. The process of the special site 24 (service server 22) will be described later.

The personal computer 12 receives data of the game ranking screen which has been generated by the special site 24, and displays the data on the display device 55.

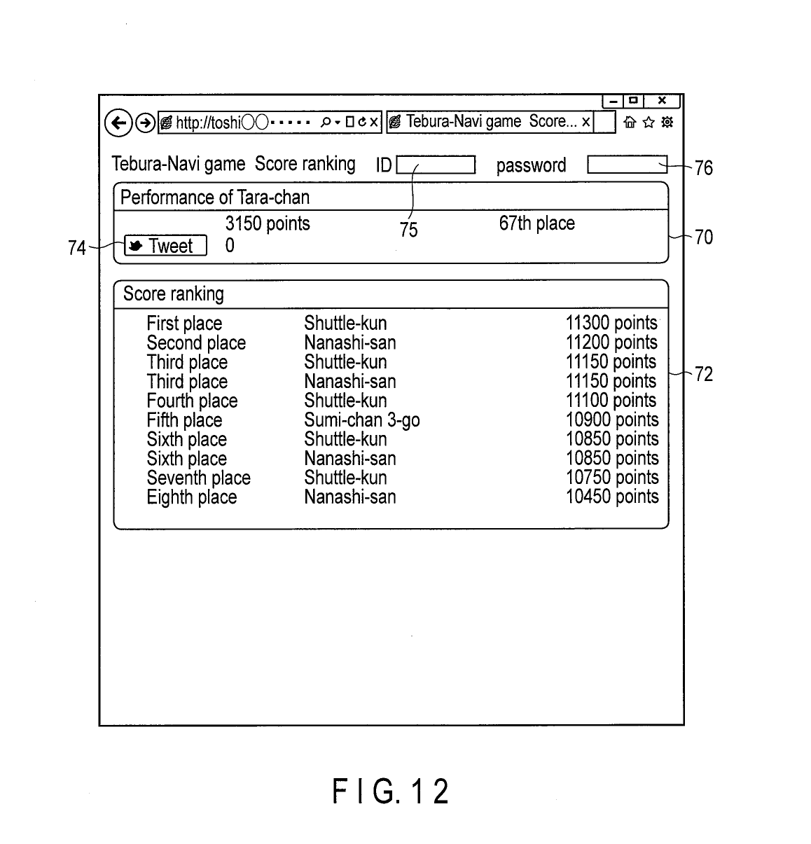

FIG. 12 shows an example of the game ranking screen which is displayed on the personal computer 12 of the embodiment.

As shown in FIG. 12, the game ranking screen includes a performance display area 70 which displays the uploaded game result, and a score ranking area 72. The performance display area 70 displays the score (315 points) and the rank (67th place), as well as the character name (“Tara-chan”) used in the game. The score ranking area 72 displays, for example, the character names and scores of the top ten in the ranking.

In the meantime, the performance display area 70 is provided with a posting button 74 in which a link to the posting page provided by the communication site 28 is set. By selecting the posting button 74, the posting page can be displayed. An example of the posting to the posting page will be described later.

In addition, the game ranking screen includes a login box (ID input field 75, password input field 76) for inputting identification data which can identify the poster (consumer A). In the ID input field 75 and password input field 76, a user ID and a password, which are pre-registered by the consumer A, can be used in order to use services provided by the special site 24 (e.g. a user support site opened by the maker of the personal computer 12). In addition, a user ID and a password, which are used in portal sites that are widely used, can also be used.

The above description is directed to, by way of example, the case of using the gesture recognition function in the game process. Alternatively, a plurality of functions (e.g. gesture recognition function and speech recognition function) may be used in one game. In addition, a plurality of game programs, which use different functions, may be installed in the personal computer 12, and the consumer may arbitrarily select the game.

Besides, in the case where the “Ranking” button 68 of the game result screen 61 has been selected, if the personal computer 12 is used in the environment in which the personal computer 12 is connectable to the Internet 16, the game ranking screen can be displayed, as described above. However, for example, the personal computer 12-1 that is disposed in the store 10 shown in FIG. 1 is not connectable to the Internet 16. In this case, the consumer may use his/her own mobile terminal 14, may input the game result from the personal computer 12, may upload the game result to the special site 24, and may view the ranking screen.

The game result may be input from the personal computer 12, for example, by a method in which the game result is input by reading the two-dimensional code 66 that is displayed on the game result screen of the personal computer 12, or a method in which the game result is received by close proximity wireless transfer.

FIG. 9 is an exemplary flow chart illustrating the operation of the mobile terminal 14 in the embodiment. A description is given of the case in which data is received from the personal computer 12 by using the two-dimensional code 66.

The consumer activates the camera 36 and image process program 32c of the mobile terminal 14, and photographs the two-dimensional code 66 which is displayed on the game result screen 61 (block C1). The CPU 30 decodes the two-dimensional code 66, based on the image captured by the camera 36, by the image process program 32c (block C2), thereby extracting data included in the two-dimensional code 66. Specifically, the CPU 30 reads the address (URL) of the special site 24 (game ranking screen), the game result (score), the character name of the character used in the game, the date, and the identification data that is unique to the two-dimensional code.

In the meantime, when the mobile terminal 14 is moved close to the close proximity wireless transfer device 58 that is provided in the personal computer 12, and close proximity wireless transfer is enabled between the close proximity wireless transfer device 38 and close proximity wireless transfer device 58, the above-described URL of the special site 24, game result data, etc. can be received from the personal computer 12 by close proximity wireless transfer. When the close proximity wireless transfer with the mobile terminal 14 has been enabled, the game program 52a of the personal computer 12 transmits, via the close proximity wireless transfer device 58, the address (URL) of the special site 24, the game result data, the image data of the image captured during the game process, etc.

Upon receiving the data from the personal computer 12, the CPU 30 accesses the special site 24, based on the URL of the special site 24 (block C3). In this case, the CPU 30 accesses the special site 24 by adding to the URL the game result (score), the character name of the character used in the game, the date, the identification data unique to the two-dimensional code, and the position data, which have been input from the personal computer 12. Thereby, the various data added to the URL can be transmitted (uploaded) to the special site 24. It is assumed, for example, that the position data is indicative of the latitude/longitude obtained by the GPS module 39 or the position of the base station 18 obtained by the communication device 37.

By transmitting the game result (score) to the special site 24 from the mobile terminal 14, the game ranking screen is generated in the special site 24. The process of the special site 24 (service server 22) will be described later.

The mobile terminal 14 receives the data of the game ranking screen which has been generated by the special site 24, and displays the data on the display device 35 (block C4).

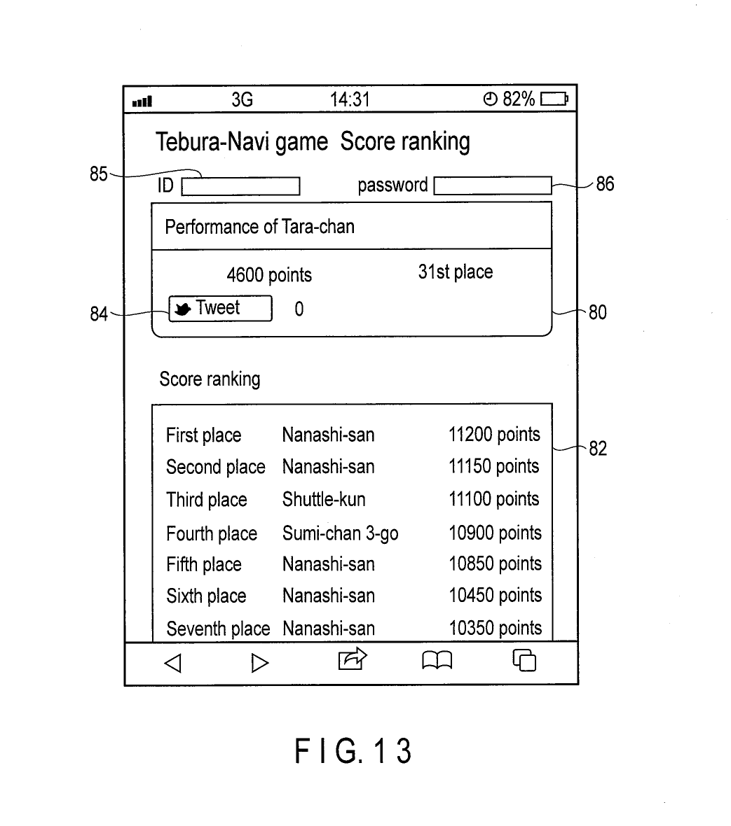

FIG. 13 shows an example of the game ranking screen which is displayed on the mobile terminal 14 of the embodiment.

As shown in FIG. 13, the game ranking screen, like the screen of FIG. 12, includes a performance display area 80 and a score ranking area 82. The performance display area 80 is provided with a posting button 84. In addition, the game ranking screen includes a login box (ID input field 85, password input field 86) for inputting identification data which can identify the poster (consumer A).

It is assumed that the user ID and the password have been input to the ID input field 85 and password input field 86 by the operation of the input device 34 (block C5). In the case where the special site 24 was previously accessed by the mobile terminal 14 and the game ranking screen was displayed, the previously input user ID and password may be displayed in advance in the ID input field 85 and password input field 86 by making use of a Web cookie.

When the posting button 84 has been selected (Yes in block C6), the CPU 30 transmits to the special site 24 the user ID and password which have been input to the ID input field 85 and password input field 86, receives via the special site 24 the data of the posting page screen which is provided by the communication site 28, and displays the data on the display device 35 (block C7). When an account for using the posting service, which is provided by the communication site 28, is recorded in advance, the CPU 30 designates this account and transmits the posting data which has been input to the posting page screen. Specifically, the posted content may be diffused by making use of the social graph that is constructed in the communication site 28.

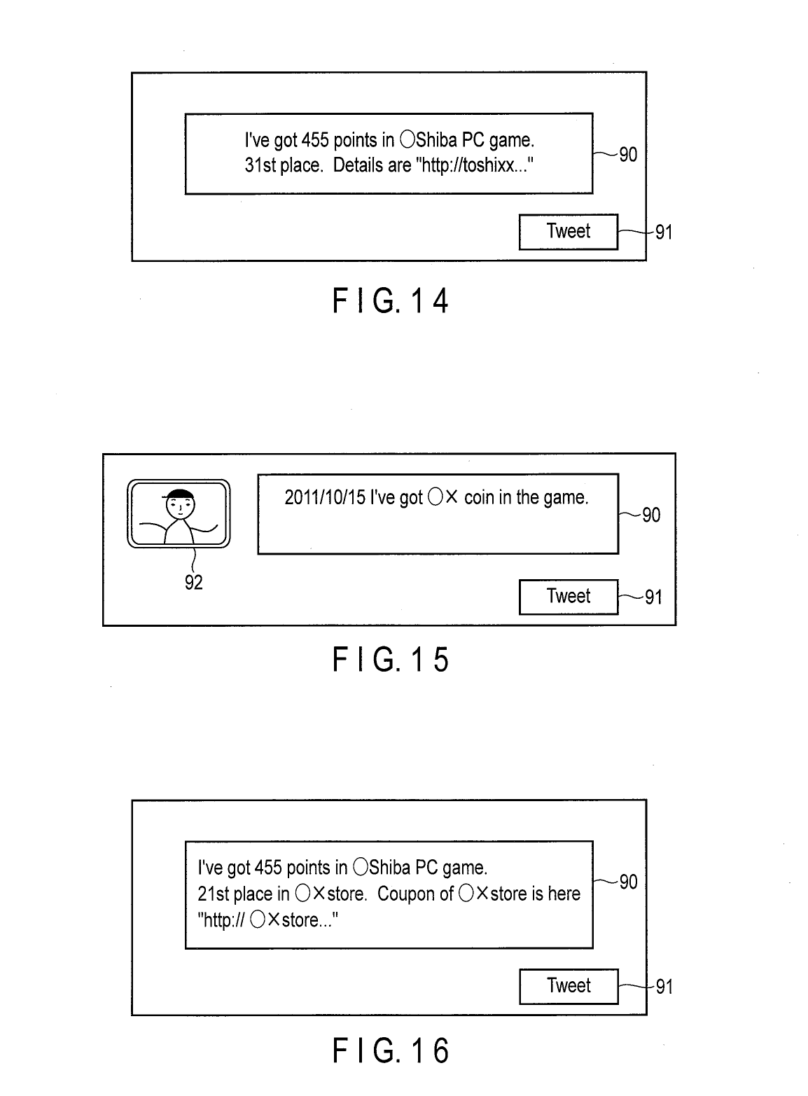

FIG. 14 shows an example of the posting page screen which is displayed on the mobile terminal 14 of the embodiment. As shown in FIG. 14, the data, which has been uploaded to the special site 24, is inserted in advance in a posting description field 90 in the posting page by the service server 22 (special site 24). In the example shown in FIG. 14, the information such as the score and rank of the game and the address (URL) of the advertisement page, which introduces the details of the personal computer 12, are inserted. Thereby, the posting of the information relating to the game is facilitated.

In the meantime, identification data for identifying the poster is added to the URL that is inserted in the posting description field 90. For example, a hash value, which is obtained based on the user ID that has been input to the game ranking screen, is added as the identification data. Specifically, a hash value is calculated in the special site 24 by using a hash function (one-way function) based on the user name so that falsification, etc. of identification data cannot be made, and the hash value is added as the identification data. Thereby, when some other user has accessed the device of the access destination (e.g. service server 22) by using the URL that is inserted in the posting description field 90, it can be discriminated which of posters has accessed the access-destination device by the URL.

The CPU 30 accepts the input or edit of the posting data (text) to the posting description field 90 in accordance with an operation on the input device 34 (block C8). Accordingly, the consumer A can alter the content inserted in the posting description field 90 in advance or to add information that is to be posted.

If the posting button 91 on the posting page screen is selected, the CPU 30 transmits the posting content which has been input in the posting description field 90 (block C9). The posting content, which has been transmitted from the mobile terminal 14, is received by the communication site 28. The posting content received by the communication site 28 is distributed to other users having relations with the poster.

FIG. 15 shows an example of the posting page screen which is displayed on the mobile terminal 14 of the embodiment. FIG. 15 shows an example in which an image, as well as text, is posted to the communication site 28.

When the mobile terminal 14 has received image data from the personal computer 12 by close proximity wireless transfer, the mobile terminal 14 transmits the image data together with the game result data at a time of accessing the special site 24. In this case, in the special site 24, an image corresponding to the image data received from the mobile terminal 14 is inserted in the posting page screen, and the resultant posting page screen is displayed on the mobile terminal 14.

In the example shown in FIG. 15, an image display field 92 is provided in addition to the posting description field 90. An image, which has been captured during the game process by the personal computer 12, is inserted in the image display field 92. Usually, an image can give a stronger impression than text alone. Thus, by posting the image, more diffusion of the posted content can be expected.

In the case where the image displayed in the image display field 92 is not to be posted, the image can arbitrarily be deleted by an operation of the input device 34.

FIG. 16 shows an example of the posting page screen which is displayed on the mobile terminal 14. In the example shown in FIG. 14, the address (URL) of the page, which introduces the details of the personal computer 12, is inserted in the posting description field 90. In FIG. 16, the URL of a coupon page, which is provided by a specific store (e.g. “ox store”) via the Internet 16, is added. Based on the position data which has been received from the mobile terminal 14, the special site 24 determines the store from which the consumer (mobile terminal 14) has made access, and inserts the URL of the coupon page corresponding to this store in the posting description field 90. Thereby, the store in which the personal computer 12 is exhibited can be advertised.

In addition, as in the above-described case, identification data for identifying the poster is added to the URL which is inserted in the posting description field 90. Thereby, when some other user has accessed the device of the access destination (e.g. service server 22) by using the URL that is inserted in the posting description field 90, it can be discriminated which of posters has accessed the access-destination device.

For example, when the special site 24 provides a coupon page, the special site 24 identifies the poster, based on the identification data that is added to the URL, and can give a benefit to this poster.

In addition, other users, who have viewed the posted content in the communication site 28, may access a coupon page, based on the URL included in the posted content, for example, by using the mobile terminal, and may display the displayed coupon page and show it to the store, thus being able to receive, for example, a discount of the purchase price of a personal computer.

Next, referring to a flow chart of FIG. 10, a description is given of a process of the special site 24 (service server 22) in the embodiment.

When access has been made from the personal computer 12 or mobile terminal 14 (Yes in block D1), the CPU 40 of the service server 22 discriminates and records, by the process of the ranking management program 42a, the game result (score), the character name of the character used in the game, the date, the identification data and the position data, based on the data which is added to the URL used for the access (block D2). In addition, when image data is transmitted from the mobile terminal 14, the image data is recorded.

The CPU 40 discriminates the region and the store of the data transmission source, based on the position data, and creates ranking data by regions and by stores, which includes the received game result (score) (block D3).

The CPU 40 generates a game ranking screen based on the ranking data (block D4) and transmits game ranking screen data to the source of access (personal computer 12 or mobile terminal 14) (block D5). Thereby, the game ranking screen, as shown in FIG. 12 or FIG. 13, is displayed on the display device of the source of access (personal computer 12 or mobile terminal 14). Although only the ranking is displayed in the examples of FIG. 12 and FIG. 13, it is possible to display advertisement information relating to commodities such as personal computers. In addition, the posting button 74, 84, in which the link to the posting page provided by the communication site 28 is set, is provided on the game ranking screen.

For example, if the posting button 84 is selected on the game ranking screen (FIG. 13) displayed on the mobile terminal 14 and access to the posting page is requested (Yes in block D6), the CPU 40 inserts, by the process of the communication management program 42b, for example, the ranking data, the URL of the advertisement page or coupon page, etc., in the posting description field of the posting page that is provided by the communication site 28, and causes the mobile terminal 14 of the source of access to display the posting page screen (block D7). Examples of the posting page screen are shown in FIG. 14, FIG. 15 and FIG. 16.

A hash value, which is calculated by using a hash function (one-way function) based on the user ID that is input to the ID input field 85 of the game ranking screen displayed on the source of access (e.g. mobile terminal 14), is added as identification data to the URL of the advertisement page or coupon page. Thereby, falsification of the identification data is prevented.

If posting is requested by an operation of the posting button 91 of the posting page screen on the mobile terminal 14 (Yes in block D8), the CPU 40 transmits the posting data, which has been input to the posting description field 90 of the posting page screen, to the communication site 28 (block D9).

In this manner, the service server 22 (special site 24) receives game results from the personal computer 12 or mobile terminal 14, totalizes the game results in the ranking format, and presents the game results in the ranking format to the mobile terminal 14, etc. at the source of access. Thereby, the access to the special site 24 can be facilitated.

In addition, the URL of the advertisement page or coupon page is inserted in the posting description field 90 of the posting page screen. Thereby, the URL is diffused through the communication site 28, and the number of accesses to the advertisement page or coupon page can be increased. In addition, the identification data for identifying the poster is added to the URL, and the profit return to the poster can be made based on the identification data. Thereby, the frequency of posting can be increased.

The profit return to the poster, which is based on the identification data, is performed in the following manner.

For example, access is made by using the URL which is included in the posted content. Thereby, coupon data, which is generated in accordance with the identification data added to the URL, can be obtained from the coupon page. The coupon data is, for instance, image data, and it is assumed that the identification number of a coupon corresponding to the identification data is included in the coupon data. When a commodity, such as personal computer 12, has been purchased in a store or the like by using this coupon data, a refund (“cash-back”) is given to the purchaser. In order to receive the cash-back, for example, evidence (e.g. a copy of the guarantee attached to the commodity) indicating that the commodity was purchased, and a coupon (e.g. printed matter of coupon data) are sent together to the maker. Upon receiving the coupon, the maker checks the evidence to determine whether the purchase is proper or not. The poster with the identification data, based on which the coupon was generated, can be identified from the coupon identification number which is printed on the coupon. The maker adds, for example, a profit (e.g. points) to the account for points of the poster indicated by the identification data. Besides, a cash-back may be given to the purchaser.

Alternatively, the profit return to the poster may be made via the Internet 16.

In this case, it is assumed that when the commodity is purchased by using the coupon, a commodity password for certifying the purchase of the commodity is given to the commodity. When the purchaser receives a return of points (“point-back”) for the purchase of the commodity, the purchaser access a site which accepts the procedure for point-back by using the personal computer or mobile terminal, logs in to the purchaser's account for points, and inputs the commodity password and the identification number of the coupon. The site, which has accepted the commodity password and the identification number of the coupon, checks whether the purchase of the commodity is proper purchase using the coupon. When the purchase is proper, the site identifies, based on the identification number of the coupon, the poster with the identification data, based on which the coupon was generated. Then, points are given to the accounts of both the poster who is indicated by the identification data, and the purchaser. The poster can use the given points, for example, for the purchase of commodities, etc.

In the above description, the game can be executed by the personal computer 12 which is exhibited in the store 10, so that the consumer may easily touch the personal computer 12. Alternatively, applications other than the game may be executed. For example, an application for creating content such as text, painting or music may be executed, so that the consumer may upload the content created by the personal computer 12 to the special site 24 by the same simple operation as described above. Thereby, like the case in which the game is installed, the consumer may be prompted to operate the personal computer 12 and to access the special site 24.

The process that has been described in connection with the present embodiment may be stored as a computer-executable program in a recording medium such as a magnetic disk (e.g. a flexible disk, a hard disk), an optical disk (e.g. a CD-ROM, a DVD) or a semiconductor memory, and may be provided to various apparatuses. The program may be transmitted via communication media and provided to various apparatuses. The computer reads the program that is stored in the recording medium or receives the program via the communication media. The operation of the apparatus is controlled by the program, thereby executing the above-described process.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
an input module configured to input, from a first device, process result data indicative of a result of a process executed by the first device, and connection data for access to a second device;
a transmitter configured to access the second device, based on the connection data, and to transmit the process result data;
a receiver configured to receive totalization data of the process result data from the second device; and
a display configured to display a totalization screen, based on the totalization data.

2. The electronic apparatus of claim 1, further comprising:
a recording module configured to record first identification data for using a posting service provided by a third device;
a posting service screen display module configured to display a posting service screen, responding to an access request to the posting service screen provided by the third device, the access request using a button provided on the totalization screen; and
a posting data transmitter configured to designate the first identification data and to transmit posting data through the posting service screen.

3. The electronic apparatus of claim 2, wherein the posting service screen display module is configured to display a result indicated by the process result data on the posting service screen.

4. The electronic apparatus of claim 1, further comprising a position data detection module configured to detect position data indicative of a position,
wherein the transmitter is configured to transmit the position data together with the process result data to the second device.

5. The electronic apparatus of claim 1, wherein the input module comprises:
a camera configured to capture an image; and
an extraction module configured to extract the process result data and the connection data, based on the image of a two-dimensional code captured by the camera.

6. The electronic apparatus of claim 1, wherein the input module comprises:
a close proximity wireless transfer module configured to execute wireless communication, when the close proximity wireless transfer module approaches the first device; and
a data reception module configured to receive the process result data and the connection data from the first device via the close proximity wireless transfer module.

7. The electronic apparatus of claim 6, wherein the input module is configured to receive image data from the first device via the close proximity wireless transfer module.

8. The electronic apparatus of claim 2, wherein the posting service screen display module is configured to display the connection data on the posting service screen.

9. The electronic apparatus of claim 8, further comprising identification data input module configured to input second identification data through the totalization screen,
wherein the posting service screen display module is configured to display the connection data to which the second identification data is added.

10. An information distribution method comprising:
inputting, from a first device, process result data indicative of a result of a process executed by the first device, and connection data for access to a second device;
accessing the second device, based on the connection data, and transmitting the process result data;
receiving totalization data of the process result data from the second device; and
displaying a totalization screen, based on the totalization data.
